(19) United States
(12) Patent Application Publication
(10) Pub. No.: US 2015/0077329 A1
(43) Pub. Date: Mar. 19, 2015

(54) EYE TRACKING-BASED USER INTERFACE METHOD AND APPARATUS

(71) Applicant: Electronics and Telecommunications Research Institute, Daejeon (KR)

(72) Inventors: Ho Sub YOON, Daejeon (KR); Chan Kyu PARK, Daejeon (KR); Jae Hong KIM, Daejeon (KR); Jong-Hyun PARK, Daejeon (KR)

(73) Assignee: Electronics and Telecommunications Research Institute, Daejeon (KR)

(21) Appl. No.: 14/189,569

(22) Filed: Feb. 25, 2014

(30) Foreign Application Priority Data
Sep. 17, 2013 (KR) 10-2013-0111985

(51) Int. Cl. G06F 3/01

(52) U.S. Cl. CPC G06F 3/013
USPC 345/156

(57) ABSTRACT

A method includes matching a pupil center position obtained from image information taken by a camera and a center position of an UI on a display panel of a terminal, and recognizing the match as a touch on the UI when the match between the pupil center position and the center position of the UI is kept for a predetermined time or more.

### RELATED APPLICATIONS(S)

This application claims the benefit of Korean Patent Application No. 10-2013-0111985, filed on Sep. 17, 2013, which is hereby incorporated by references as if fully set forth herein.

### FIELD OF THE INVENTION

The present invention relates to a user interface of a terminal, and more specifically, to an eye tracking-based user interface method and apparatus suitable to provide a user interface of a terminal based on an eye tracking in non-contact type.

### BACKGROUND OF THE INVENTION

Recently, with a definite development in digital technology, technologies to analyze image information and classify it into specific areas or specific portions are under development. One of such analysis technologies includes a face recognition technology and an eye tracking and recognition technology, which is under study and development in a variety of schemes and from various angles in order to integrate into devices that perform security technology or the like.

Here, in order to match the position on a screen and position of eye, a conventional eye tracking system uses a scheme in which the position of eye is tracked using an eye glass for eye tracking or a stereo camera device and an infrared illumination.

However, the conventional eye tracking system has a problem in that its application is limited since it requires special devices such as an eye tracking glass, a stereo camera device or an infrared illumination, that is, it is not easy to apply the conventional eye tracking system to a mobile phone, a smart phone, a smart pad, a notebook computer, etc.

### SUMMARY OF THE INVENTION

In view of the above, the present invention provides a user interface apparatus and method in non-contact type that is capable of detecting up/down and left/right motion instead of complicated eye motion using one camera and applying the detected motion to a user interface UI of a mobile terminal.

The subject of the present invention is not limited to the above-mentioned, and other subjects to be solved which were not mentioned can be understood by those skilled in the art from the following description.

The present invention matches a pupil center position obtained from image information and a center position of a UI in a display panel of a terminal and recognizes the matching as a touch to the center position of the UI when the matching is kept for a predetermined time or more, thereby realizing a non-contact user interface in a mobile terminal having only one camera and improving security by applying the user interface to a function to unlock the mobile terminal.

Further, the present invention provides a non-contact user interface using an eye pupil not a contact type touch using hands. Therefore, its application may be extended to the disabled who do not use hands freely and the like.

Furthermore, the present invention provides a non-contact user interface using an eye pupil, not a contact type touch using hands. Therefore, finger print patterns do not remain on the touch panel when applied to unlock a mobile terminal, thereby effectively blocking an illegal use (or exposure) of unlock pattern due to remaining finger print patterns on the touch panel in view of security.

In accordance with an aspect of the exemplary embodiment of the present invention, there is provided an eye tracking-based UI (User Interface) method, which includes matching a pupil center position obtained from image information taken by a camera and a center position of an UI on a display panel of a terminal, and recognizing the match as a touch on the UI when the match between the pupil center position and the center position of the UI is kept for a predetermined time or more.

In accordance with another aspect of the exemplary embodiment of the present invention, there is provided an eye tracking-based UI (User Interface) method, which includes detecting an eye area from image information taken by a camera, detecting a pupil center position from the detected eye area, detecting left/right and up/down reference positions of an eye in the eye area, matching the left/right and up/down reference positions and a center position of a UI on a display panel of the terminal, and recognizing the match as a touch on the UI when the pupil center position is kept for a predetermined time or more in the state that the left/right and up/down reference positions and the center position of the UI were matched.

In the exemplary embodiment, said detecting the eye may includes detecting a face area from the image information, and detecting the eye area from the detected face area.

In the exemplary embodiment, the left/right reference positions of the eye may be left/right corners of the eye.

In the exemplary embodiment, the up/down reference positions of the eye may be points where a vertical line perpendicular to a straight line connecting the left/right reference positions at the center point of the straight line meets both eyelids.

In the exemplary embodiment, the method further includes detecting new left/right reference positions when there are points whose an up/down distance between eyelids is relatively large around the up/down reference positions, and adjusting the up/down reference positions based on the newly detected left/right reference positions.

In the exemplary embodiment, the method further include converting a display representation of the UI into an activation pattern when recognizing the match as the touch.

In the exemplary embodiment, the touch may be a UI to unlock the terminal.

In the exemplary embodiment, the touch may be a UI to activate or select the operation menu of the terminal.

In the exemplary embodiment, the UI may be any one of a pattern, an icon, a button and a menu.

In accordance with further another aspect of the exemplary embodiment of the present invention, there is provided an eye tracking-based UI (User Interface) apparatus, which includes an eye detection unit configured to extract an eye position from image information taken by a camera and detect an eye area, a pupil detection unit configured to detect a pupil center position from the detected eye area, a position detection unit configured to detect left/right and up/down reference positions of an eye in the eye area, a position matching unit configured to match the detected left/right and up/down reference positions and a center position of a UI in a display panel of a terminal, a motion detection unit configured to detect whether the pupil center position moves in the state that the left/right and up/down reference positions and the center position of the UI are matched, and a touch recognition unit configured to recognize the matching as a touch for the UI when it is notified that the pupil center position does not move for a predetermined time or more.

In the exemplary embodiment, the position detection unit may be configured to detect left/right corners of the eye as the left/right reference positions of the eye.

In the exemplary embodiment, the position detection unit may be configured to detect points where a vertical line perpendicular to a straight line connecting the left/right reference positions at the center point of the straight line meet both eyelids, as the up/down reference positions of the eye.

In the exemplary embodiment, the position detection unit may be configured to detect new left/right reference positions when there are points whose up/down distance between eyelids is relatively large around the up/down reference positions, and adjust the up/down reference positions based on the newly detected left/right reference positions.

In the exemplary embodiment, the apparatus further include a representation conversion unit configured to convert a display representation of the UI into an activation pattern when recognizing the match as the touch.

### BRIEF DESCRIPTION OF THE DRAWINGS

The above and other objects and features of the present invention will become apparent from the following description of embodiments given in conjunction with the accompanying drawings, in which:

FIG. 1 is a block diagram of an eye tracking-based user interface apparatus in accordance with an embodiment of the present invention;

FIG. 2 is a flow chart illustrating a main process to realize a non-contact user interface by matching up/down and left/right reference positions of an eye and the center position of a UI in accordance with an embodiment of the present invention;

FIG. 3 is a photograph showing an example in which a pupil center position of an eye is detected in accordance with the present invention;

FIG. 4 is a photograph showing an example in which up/down and left/right reference positions of an eye are detected in accordance with the present invention;

FIG. 5 is an illustrative diagram of a screen lock pattern that converts a display representation of a UI to an activation pattern when a pupil center position is kept for a predetermined time and it is recognized as a touch of a user interface in accordance with the present invention; and

FIG. 6 is an illustrative diagram showing an example of a pattern touch to perform a screen unlock when an eye tracking-based user interface scheme of the present invention is applied to a screen unlock pattern of a mobile terminal.

### DETAILED DESCRIPTION OF THE EMBODIMENTS

The advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims.

In the following description, well-known functions or constitutions will not be described in detail if they would unnecessarily obscure the embodiments of the invention. Further, the terminologies to be described below are defined in consideration of functions in the invention and may vary depending on a user's or operator's intention or practice. Accordingly, the definition may be made on a basis of the content throughout the specification.

Hereinafter, embodiments of the present invention will be described in detail with reference to the accompanying drawings.

First, in order to leave no room for confusion in describing embodiments of the present invention, each term is defined as follows.

### EMBODIMENTS

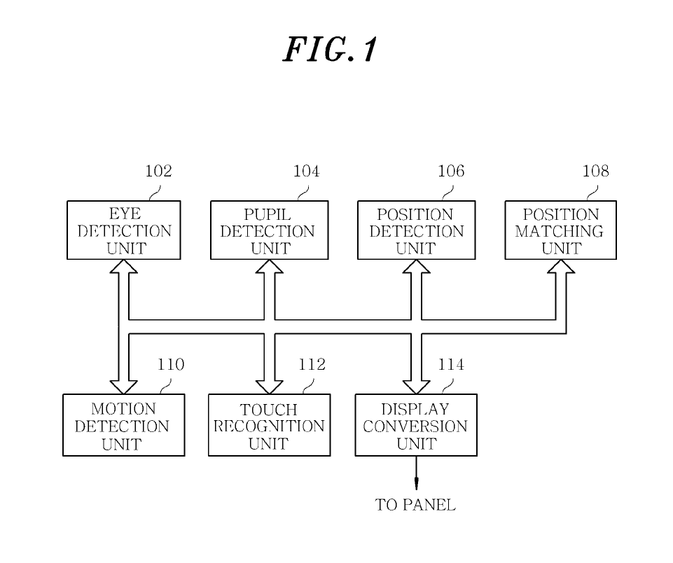

FIG. 1 is a block diagram illustrating an eye tracking-based user interface apparatus in accordance with an embodiment of the present invention. The eye tracking-based user interface apparatus includes an eye detection unit 102, a pupil detection unit 104, a position detection unit 106, a position matching unit 108, a motion detection unit 110, a touch recognition unit 112, a representation conversion unit 114 and a position adjustment unit 116.

Referring to FIG. 1, the eye detection unit 102 extracts an eye position from image information taken by a camera (not shown) of a mobile terminal and detects an eye area. The eye detection unit 102 detects a face image of a user from the image information first and then the eye (or the eye area), or detects the eye using an eye position detector only. The eye area detected is then transferred to the pupil detection unit 104.

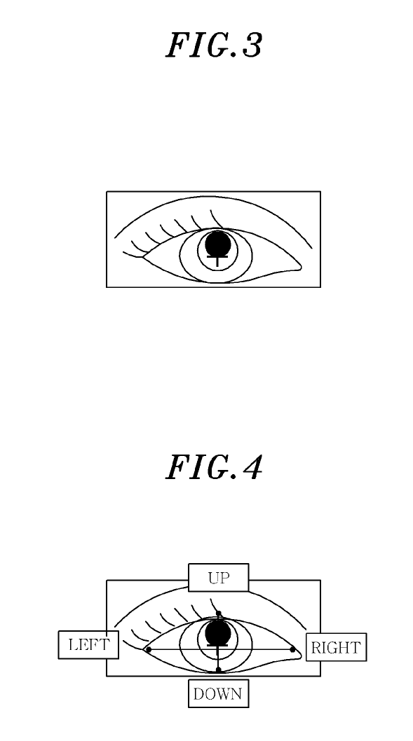

The pupil detection unit 104 functions to detect a pupil portion from the detected eye area and in turn the center position of the pupil by applying a typical image processing algorithm which is well-known in the art, as shown in FIG. 3 for example.

The position detection unit 106 detects left/right and up/down reference positions of an eye in the detected eye area. In this case, for example, as shown in FIG. 4, left/right reference positions of the eye may be left/right corners of the eye where reference positions of the left and the right become end points of the corners of the eye, respectively, and a line connecting both reference positions (i.e., the left/right reference positions) may be a straight line or an oblique line. Further, the up/down reference positions of the eye may be points where a vertical line perpendicular to a straight line connecting the left/right reference positions at the center point of the straight line meets both eyelids. In this case, the found up/down reference positions may normally be points in which up/down distance between eyelids are the largest one.

Further, the position detection unit 106 detects the up/down reference positions and then checks whether there are points whose up/down distance between eyelids is relatively large around the detected up/down reference positions. Further, the position detection unit 106 detects new left/right reference positions considering that the left/right reference positions are erroneously found when there are points whose up/down distance is relatively large, and then adjusts the up/down reference positions based on the newly detected left/right reference positions.

In this regard, for the detection of the reference positions, it may be possible to capture only the eye motion by using the reference positions in the case where the user's head may shake unconsciously due to the change in the eye-sight of the user so that the head motion may be influenced on the eye motion. That is, when a head motion occurs, it may be possible to calculate only the eye motion excluding the head motion by performing the relative movement of the reference position accordingly and calculating the eye motion based on the moved reference positions.

Meanwhile, the position matching unit 108 matches the detected left/right and up/down reference positions of the eye and the center position of the UI (for example, a pattern, an icon, a menu, etc. to be touched in non-contact type) in a display panel of the mobile terminal (not shown) and the like.

The motion detection unit 110 detects whether the pupil center position moves in the state that the left/right and up/down reference positions of the eye and the center position of the UI were matched and the like. A pupil motion sensing signal or a pupil motion stopping signal detected by the motion detection unit 110 are provided to the touch recognition unit 112.

The touch recognition unit 112 checks whether the pupil center position is kept for a predetermined time or more (for example, 2 seconds, 3 seconds, etc.) or moves within the predetermined time in the state that the left/right and up/down reference positions of the eye and the center position of the UI were matched, based on a pupil motion sensing signal or a pupil motion stopping signal provided from the motion detection unit 110. When it is determined that the pupil center position is not moved but is kept for a predetermined time (for example, 2 seconds, 3 seconds, etc.), the touch recognition unit 112 recognizes it as a touch on the user interface.

In this connection, the recognized touch may be a user interface to unlock the mobile terminal, or a user interface to activate or select an operation menu of the mobile terminal, and a signal representing such a recognized touch is sent to the representation conversion unit 114.

Finally, the representation conversion unit 114 generates a representation conversion signal to convert a display representation of the relevant UI (for example, a pattern, an icon, a button, a menu, etc.) into an activation pattern when a touch recognition signal is received from the touch recognition unit 112 and then transfer the representation conversion signal to a display panel that is not shown here.

For example, as shown in FIG. 5, assuming that a UI is applied to a pattern for screen unlock and a pattern having n5 is recognized as a touch by an eye pupil, the pattern of n5 may be converted from a one line circle (for example, an inactivation pattern) to a double line circle (for example, an activation pattern). That is, FIG. 5 is an exemplary view of a screen lock pattern that converts a display representation of a UI into an activation pattern (a double line circle) when the pupil center position is kept for a predetermined time and is recognized as a touch of a user interface in accordance with the present invention.

Next, a description will be made in detail on a series of operations of providing a non-contact user interface by matching the up/down and left/right reference positions of the eye and the center position of the UI using a user interface apparatus of the present invention having the aforementioned configuration.

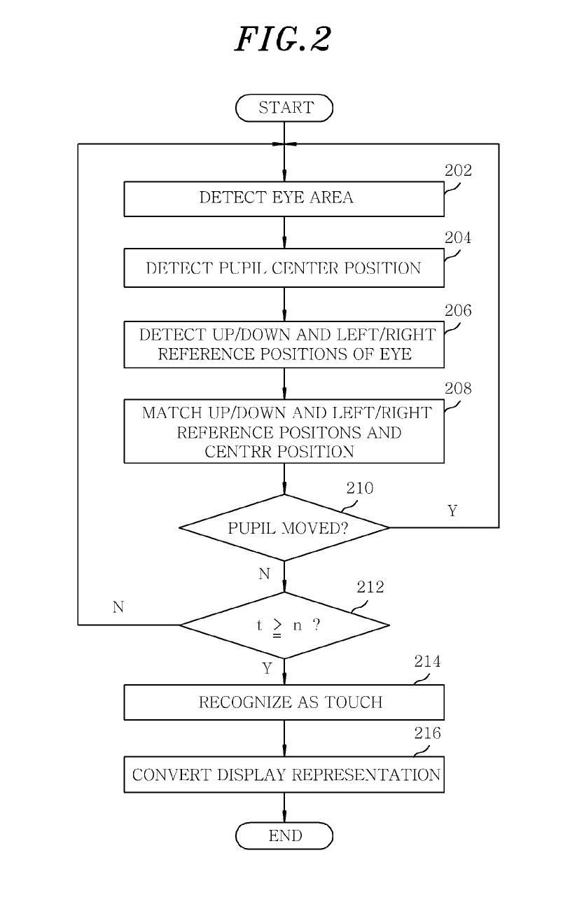

FIG. 2 is a flow chart of a main process of realizing a non-contact user interface by matching up/down and left/right reference positions of an eye and the center position of a UI in accordance with an embodiment of the present invention.

Referring to FIG. 2, the eye detection unit 102 detects an eye area by extracting an eye position from image information inputted from a camera of a mobile terminal at block 202. More specifically, the eye detection unit 102 may detect the eye (or eye area) after detecting a face shape of a user from the image information first, or detect the eye using an eye position detector only.

Next, the pupil detection unit 104 detects a pupil portion from the detected eye area, and then detects a pupil center position at block 204.

Subsequently, the position detection unit 106 detects left/right and up/down reference positions of the eye in the detected eye area at block 206. In this case, the left/right reference positions of the eye may be left/right eye corners, and reference positions of the left and the right may be end points of the eye corners, respectively, where a line connecting the two reference positions (left/right reference positions) becomes a straight line or an oblique line. Further, the up/down reference positions of the eye may be points where a vertical line perpendicular to a straight line connecting the left/right reference positions at the center point of the straight line meets both eyelids. In general, the up/down reference positions may be points in which up/down distance between eyelids are the largest one.

During the detection of the reference positions, there may be points (positions) around the detected up/down reference positions, whose up/down distance between eyelids is relatively large. In this case, the position detection unit 106 may regard it as the left/right reference positions were erroneously found. Accordingly the position detection unit 106 may detect new left/right reference positions and then adjust up/down reference positions based on the newly detected left/right reference positions.

Again, the position matching unit 108 matches the detected left/right and up/down reference positions of the eye and the center position of the UI (for example, a pattern, an icon, a button, a menu etc.) on the display panel of the mobile terminal at block 208, and the motion detection unit 110 checks whether the pupil center position moves within a predetermined time in the state that the left/right and up/down positions of the eye and the center position of the UI were matched at blocks 210 and 212). That is, it is checked whether the pupil center position moves before an elapsed time ‘t’ reaches a predetermined time ‘n’ (for example, 2 seconds, 3 seconds, etc.) after the left/right and up/down reference positions of the eye were matched to the center position of the UI displayed on the display panel of the mobile terminal.

As a result of the check in block 212, when it is determined that there is no pupil motion until the elapsed time ‘t’ reaches the predetermined time ‘n’, the touch recognition unit 112 recognizes it as a touch on the user interface at block 214 and generates a relevant touch recognition signal. Here, the recognized touch may be a user interface to unlock the mobile terminal or a user interface to activate or select an operation menu of the mobile terminal.

In response to the touch recognition signal, the representation conversion unit 114 generates a representation conversion signal to convert a display representation of the relevant UI (for example, a pattern, an icon, a button, a menu, etc.) into an activation pattern and transfers it to a display panel, whereby the display representation of the UI displayed on the display panel is converted into the activation pattern at block 216.

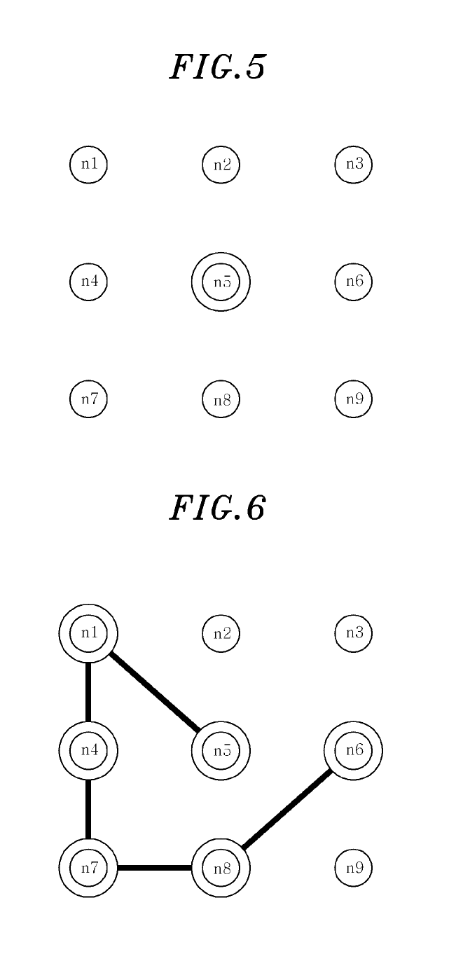

FIG. 6 is an illustrative diagram of an example of a touch pattern to unlock a screen when an eye tracking-based user interface of the present invention is applied to a screen unlock pattern of a mobile terminal.

Referring to FIG. 6, it is assumed that the UI method is applied to unlock a screen using a pattern having a plurality of pattern elements n1 to n9, a reference time to recognize each pattern element as a touch is set as 2 seconds, and an unlock pattern is set as a succession of n5-n1-n4-n7-n8-n6. Then, the user of the mobile terminal may perform a non-contact user interface method for screen unlock by a sequential eye tracking, that is, looking at a pattern element n5 for 2 seconds, and then looking at a pattern element n1 for 2 seconds by moving a pupil, and then looking at a pattern element n4 for 2 seconds by moving a pupil, and then looking at a pattern element n7 for 2 seconds by moving a pupil, and then looking at a pattern element n8 for 2 seconds by moving a pupil, and then looking at a pattern element n6 for 2 seconds by moving a pupil.

The combinations of the each block of the block diagram and each operation of the flow chart may be performed by computer program instructions. Because the computer program instructions may be loaded on a general purpose computer, a special purpose computer, or a processor of programmable data processing equipment, the instructions performed through the computer or the processor of the programmable data processing equipment may generate the means performing functions described in the each block of the block diagram and each operation of the flow chart. Because the computer program instructions may be stored in a computer usable memory or computer readable memory which is capable of intending to a computer or other programmable data processing equipment in order to embody a function in a specific way, the instructions stored in the computer usable memory or computer readable memory may produce a manufactured item involving the instruction means performing functions described in the each block of the block diagram and each operation of the flow chart. Because the computer program instructions may be loaded on the computer or other programmable data processing equipment, the instructions performed by the computer or programmable data processing equipment may provide the operations for executing the functions described in the each block of the block diagram and each operation of the flow chart by a series of functional operations being performed on the computer or programmable data processing equipment, thereby a process executed by a computer being generated.

Moreover, the respective blocks or the respective sequences in the appended drawings may indicate modules, segments, or some of codes including at least one executable instruction for executing a specific logical function(s). In several alternative embodiments, it is noticed that the functions described in the blocks or the sequences may run out of order. For example, two successive blocks and sequences may be substantially executed simultaneously or often in reverse order according to corresponding functions.

The explanation as set forth above is merely described a technical idea of the exemplary embodiments of the present invention, and it will be understood by those skilled in the art to which this invention belongs that various changes and modifications may be made without departing from the scope of the essential characteristics of the embodiments of the present invention. That is, the exemplary embodiments disclosed herein are not used to limit the technical idea of the present invention, but to explain the present invention, and the scope of the technical idea of the present invention is not limited to these embodiments.

Therefore, the scope of protection of the present invention should be construed as defined in the following claims and changes, modifications and equivalents that fall within the technical idea of the present invention are intended to be embraced by the scope of the claims of the present invention.

What is claimed is:

1. An eye tracking-based UI (User Interface) method, comprising:
matching a pupil center position obtained from image information taken by a camera and a center position of an UI on a display panel of a terminal; and
recognizing the match as a touch on the UI when the match between the pupil center position and the center position of the UI is kept for a predetermined time or more.

2. The eye tracking-based UI method of claim 1, wherein the touch is a UI to unlock the terminal.

3. The eye tracking-based UI method of claim 1, wherein the touch is a UI to activate or select an operation menu of operation of the terminal.

4. An eye tracking-based UI (User Interface) method, comprising:
detecting an eye area from image information taken by a camera;
detecting a pupil center position from the detected eye area;
detecting left/right and up/down reference positions of an eye in the eye area;
matching the left/right and up/down reference positions and a center position of a UI on a display panel of the terminal; and
recognizing the match as a touch on the UI when the pupil center position is kept for a predetermined time or more in the state that the left/right and up/down reference positions and the center position of the UI were matched.

5. The eye tracking-based UI method of claim 4, wherein said detecting the eye area comprises:
detecting a face area from the image information; and
detecting the eye area from the detected face area.

6. The eye tracking-based UI method of claim 4, wherein the left/right reference positions of the eye are left/right corners of the eye.

7. The eye tracking-based UI method of claim 6, wherein the up/down reference positions of the eye are points where a vertical line perpendicular to a straight line connecting the left/right reference positions at the center point of the straight line meets both eyelids.

8. The eye tracking-based UI method of claim 7, further comprising:
detecting new left/right reference positions when there are points whose an up/down distance between eyelids is relatively large around the up/down reference positions; and
adjusting the up/down reference positions based on the newly detected left/right reference positions.

9. The eye tracking-based UI method of claim 4, further comprising:
converting a display representation of the UI into an activation pattern when recognizing the match as the touch.

10. The eye tracking-based UI method of claim 4, wherein the touch is a UI to unlock the terminal.

11. The eye tracking-based UI method of claim 4, wherein the touch is a UI to activate or select the operation menu of the terminal.

12. The eye tracking-based UI method of claim 4, wherein the UI is any one of a pattern, an icon, a button and a menu.

13. An eye tracking-based UI (User Interface) apparatus, comprising:
an eye detection unit configured to extract an eye position from image information taken by a camera and detect an eye area;
a pupil detection unit configured to detect a pupil center position from the detected eye area;
a position detection unit configured to detect left/right and up/down reference positions of an eye in the eye area;
a position matching unit configured to match the detected left/right and up/down reference positions and a center position of a UI in a display panel of a terminal;
a motion detection unit configured to detect whether the pupil center position moves in the state that the left/right and up/down reference positions and the center position of the UI are matched; and
a touch recognition unit configured to recognize the matching as a touch for the UI when it is notified that the pupil center position does not move for a predetermined time or more.

14. The eye tracking-based UI apparatus of claim 13, wherein the position detection unit is configured to detect left/right corners of the eye as the left/right reference positions of the eye.

15. The eye tracking-based UI apparatus of claim 14, wherein the position detection unit is configured to detect points where a vertical line perpendicular to a straight line connect ing the left/right reference positions at the center point of the straight line meets both eyelids, as the up/down reference positions of the eye.

16. The eye tracking-based UI apparatus of claim 15, wherein the position detection unit is configured to detect new left/right reference positions when there are points whose up/down distance between eyelids is relatively large around the up/down reference positions, and adjust the up/down reference positions based on the newly detected left/right reference positions.

17. The eye tracking-based UI apparatus of claim 13, further comprising a representation conversion unit configured to convert a display representation of the UI into an activation pattern when recognizing the match as the touch.

18. The eye tracking-based UI apparatus of claim 13, wherein the touch is a UI to unlock the terminal.

19. The eye tracking-based UI apparatus of claim 13, wherein the touch is a UI to activate or select the menu of the terminal.
